(19) United States
(12) Patent Application Publication
(10) Pub. No.: US 2016/0238724 A1
(43) Pub. Date: Aug. 18, 2016

(54) METHODS AND SYSTEMS OF GENERATING A VELOCITY MODEL

(71) Applicant: CGG Services SA, Massy (FR)

(72) Inventor: Thomas Bardainne, Paris (FR)

(21) Appl. No.: 14/655,025

(22) PCT Filed: Dec. 5, 2014
(86) PCT No.: PCT/IB2014/003043

§ 371 Date: Jun. 23, 2015

Related U.S. Application Data
(60) Provisional application No. 61/921,963, filed on Dec. 30, 2013.

(51) Int. Cl. G01V 1/30; G01V 1/28

(52) U.S. Cl. CPC G01V 1/303; G01V 1/288; G01V 1/282; G01V 1/284; G01V 2210/1234; G01V 2210/6222

(57) ABSTRACT

The present disclosure includes a method comprising detecting arrival times of a P-wave and an S-wave at a plurality of receivers, the P-wave and the S-wave generated by a calibration event. The method also comprises fitting the P-wave arrival times as a first curve on a plot of distance versus time based on a first velocity model with a first type and fitting the S-wave arrival times as a second curve on the plot based on a second velocity model with a second type similar to the first type. The method additionally comprises determining a difference between a first origin time based on the first curve and a second origin time based on the second curve, and upon a determination that the difference between the first origin time and the second origin time is within a convergence criteria, selecting the first velocity model as a calibrated velocity model.

### CROSS-REFERENCE TO RELATED APPLICATION

This application claims the benefit under 35 U.S.C. §119(e) of U.S. Provisional Application Ser. No. 61/921,963 filed on Dec. 30, 2013, which is incorporated by reference in its entirety for all purposes.

### TECHNICAL FIELD OF THE DISCLOSURE

This disclosure relates generally to seismic analysis, and in particular, to methods and systems for generating a velocity model.

### BACKGROUND

Seismic surveying or seismic exploration, whether on land or at sea, is accomplished by observing a seismic energy signal that propagates into the Earth. Propagating seismic energy is partially reflected, refracted, diffracted and otherwise affected by one or more geologic structures within the Earth, for example, by interfaces between underground formations having varying acoustic impedances. The affected seismic energy is detected by receivers, or seismic detectors, placed at or near the Earth's surface, in a body of water, or below ground in a wellbore or mineshaft. The resulting signals are recorded and processed to generate information relating to the physical properties of subsurface formations. Some seismic exploration, surveying, or monitoring may be done passively, or without generating a seismic energy signal explicitly for the purpose of recording the response. One example of passive seismic monitoring includes monitoring for seismic waves associated with microseismic events.

Seismic waves generated by a microseismic event include P-waves and S-waves. A P-wave is the wave studied in conventional seismic data and is an elastic body wave or sound wave in which particles oscillate in the direction the wave propagates. P-waves incident on an interface at other than normal incidence can produce reflected and transmitted S-waves, otherwise known as converted waves.

An S-wave is an elastic body wave in which particles oscillate perpendicular to the direction in which the wave propagates. S-waves, also known as shear waves, travel more slowly than P-waves and cannot travel through fluids because fluids do not support shear. Recording of S-waves requires receivers coupled to the solid Earth and their interpretation can allow determination of rock properties such as fracture density and orientation, Poisson's ratio, and rock type by cross-plotting P-wave and S-wave velocities and other techniques. S-waves propagate with particle motion parallel to the wavefront from a microseismic event, or in other words, propagate with particle motion perpendicular to the direction of wave propagation.

Velocity of P-waves and S-waves through the Earth is very complex and may vary depending on a variety of factors, for example, depth, rock material, size of rock layers, orientation of rock layers relative to the surface or other rock layers, fractures within rock layers, and orientation of fractures within rock layers. Due to this complexity, velocity models make various assumptions to provide an estimation of the velocity of these seismic waves through the Earth. Velocity models are not completely accurate, but instead are a best-fit approximation of the propagation rate of seismic waves through the Earth while recognizing there may be errors due to the assumptions utilized in constructing the model. Some velocity models assume a homogenous velocity through the Earth, and are sometimes referred to as zero-dimensional models (0D) or homogenous wave models. Some velocity models account for variations in velocity in depth, and are sometimes referred to as one-dimensional (1D) models. Some models account for vertical and lateral variations in velocity, and are sometimes referred to as three-dimensional (3D) models. Some velocity models account for variations in velocity based on the direction of wave propagation, referred to as anisotropy, which may be caused by the orientation of rock layers or orientation of fractures within rock layers. Such a model may be an even higher order model. Some velocity models assume the velocity is isotropic throughout the Earth, or in other words, that the velocity is the same regardless of the direction of wave propagation.

Regardless of the complexity used in a particular velocity model, velocity models in active seismic monitoring are typically based exclusively on P-waves. However, this is because the origin time and origin location of the human-initiated seismic event is known. In some passive microseismic monitoring situations, a velocity model may be generated based on a human-initiated seismic event, and then the velocity model is generated with a known origin time and origin location, and then used in passive microseismic monitoring. However, in situations where the origin time is unknown, the velocity model may be inaccurate and produce unfavorable results. This may be because an unacceptable number of assumptions simplifying the velocity model have been used, without any verification of the accuracy of the velocity model. This often leads to a strongly over-estimated velocity, which is particularly erroneous for long offsets from the origin point of a microseismic event. The present disclosure provides a solution for generating a velocity model with improved accuracy because it is based on both P-wave and S-wave data.

### SUMMARY

In one embodiment, a method of processing seismic data comprises detecting arrival times of both a P-wave and an S-wave at a plurality of receivers, the P-wave and the S-wave generated by a calibration event in a subterranean formation. The method also comprises fitting the P-wave arrival times as a first curve on a plot of distance versus time based on a first velocity model with a first type, and fitting the S-wave arrival times as a second curve on the plot of distance versus time based on a second velocity model with a second type similar to the first type. The method additionally comprises determining a difference between a first origin time based on the first curve and a second origin time based on the second curve, and upon a determination that the difference between the first origin time and the second origin time is within a convergence criteria, selecting the first velocity model as a calibrated velocity model of the subterranean formation.

In another embodiment, a system for processing seismic data comprises a plurality of receivers to detect both a P-wave and an S-wave of a calibration event in a subterranean formation, a network communicatively coupled to the plurality of receivers, and a computing unit communicatively coupled to the plurality of receivers via the network, the computing unit comprising a processing unit and a memory unit coupled to the processing unit. The memory unit includes instructions that, when executed by the processing unit, are configured to detect arrival times of both the P-wave and the S-wave at the plurality of receivers. The instructions are also configured to fit the P-wave arrival times as a first curve on a plot of distance versus time based on a first velocity model with a first type and fit the S-wave arrival times as a second curve on the plot of distance versus time based on a second velocity model with a second type similar to the first type. The instructions are further configured to determine a difference between a first origin time based on the first curve and a second origin time based on the second curve, and upon a determination that the difference between the first origin time and the second origin time is within a convergence criteria, select the first velocity model as a calibrated velocity model of the subterranean formation. Upon a determination that the difference between the first origin time and the second origin time is outside the convergence criteria, the instructions are further configured to re-fit the P-wave arrival times to a third curve based on a third velocity model with a third type and re-fit the S-wave arrival times to a fourth curve based on a fourth velocity model with a fourth type similar to the third type. The instructions are further configured to determine a difference between a third origin time based on the third curve and a fourth origin time based on the fourth curve, and upon a determination that the difference between the third origin time and the fourth origin time is within the convergence criteria, select the third velocity model as the calibrated velocity model of the subterranean formation.

In an additional embodiment, the present disclosure comprises a non-transitory computer-readable medium containing instructions for processing seismic data that, when executed by a processor, are configured to receive data indicative of arrival times of both a P-wave and an S-wave at a plurality of receivers, the P-wave and S-wave generated by a calibration event in a subterranean formation. The instructions are further configured to fit the P-wave arrival times as a first curve on a plot of distance versus time based on a first velocity model with a first type indicating a first origin time, and fit the S-wave arrival times as a second curve on the plot of distance versus time based on a second velocity model with a second type similar to the first type. The instructions are additionally configured to determine a difference between a first origin time based on the first curve and a second origin time based on the second curve, and upon a determination that the difference between the first origin time and the second origin time is within a convergence criteria, select the first velocity model as a calibrated velocity model of the subterranean formation.

### BRIEF DESCRIPTION OF THE DRAWINGS

For a more complete understanding of the present disclosure and its features, reference is now made to the following description, taken in conjunction with the accompanying drawings, in which like reference numbers indicate like features and wherein:

FIG. 1 illustrates an example of a calibration event generating a P-wave and an S-wave, in accordance with some embodiments of the present disclosure;

FIG. 2 illustrates an example of raw data indicative of P-wave and S-wave arrival times, in accordance with some embodiments of the present disclosure;

FIG. 3 illustrates an example of a plot of P-wave and S-wave arrival times against distance, in accordance with some embodiments of the present disclosure;

FIG. 4 illustrates an example of P-wave and S-wave arrival times fit to a curve on a plot of distance vs. time, in accordance with some embodiments of the present disclosure;

FIG. 5 illustrates another example of P-wave and S-wave arrival times fit to a curve on a plot of distance vs. time, in accordance with some embodiments of the present disclosure;

FIG. 6 illustrates an additional example of P-wave and S-wave arrival times fit to a curve on a plot of distance vs. time, in accordance with some embodiments of the present disclosure;

FIG. 7 illustrates an example of a finalized fit of P-wave arrival times on a plot of distance vs. time, in accordance with some embodiments of the present disclosure;

FIG. 8 illustrates an example of a flowchart illustrating a process to generate a calibrated velocity model, in accordance with some embodiments of the present disclosure;

FIG. 9 illustrates another example of a flowchart illustrating a process to generate a calibrated velocity model, in accordance with some embodiments of the present disclosure;

FIG. 10 illustrates an example of a system for generating a calibrated velocity model, in accordance with some embodiments of the present disclosure; and

FIG. 11 illustrates another example of a system for generating a calibrated velocity model, in accordance with some embodiments of the present disclosure.

### DETAILED DESCRIPTION

The present disclosure relates to the generation of a calibrated velocity model for seismic analysis based on both P-waves and S-waves. A plurality of receivers are deployed to passively monitor for both P-waves and S-waves. Once a calibration event occurs, the P-waves and S-waves from the calibration event are detected at the plurality of receivers and data is received regarding the detected P-waves and S-waves. The arrival times of the P-waves and S-waves are then plotted on a graph of distance vs. time. A curve defining a velocity model of a given type is then fit to the P-wave arrival times and another curve defining a velocity model of the same or similar type is fit to the S-wave arrival times. Each curve indicates an origin time of the calibration event as the point that the curve intersects the time axis. Depending on how far apart the two origin times for the two curves are, the accuracy of the velocity model can be observed. For example, if there is a large disparity between the two origin times, the velocity model is not very accurate. If they are very close or identical, then the velocity model is accurate. If the velocity model is not very accurate, the type of the velocity model for the P-waves and the S-waves is varied and the origin times are compared again. For example, the complexity of the velocity models may be increased. Once an acceptable level of accuracy is reached, the velocity model can then be selected as a calibrated velocity model. This velocity model can then be used to determine the location of detected microseismic events.

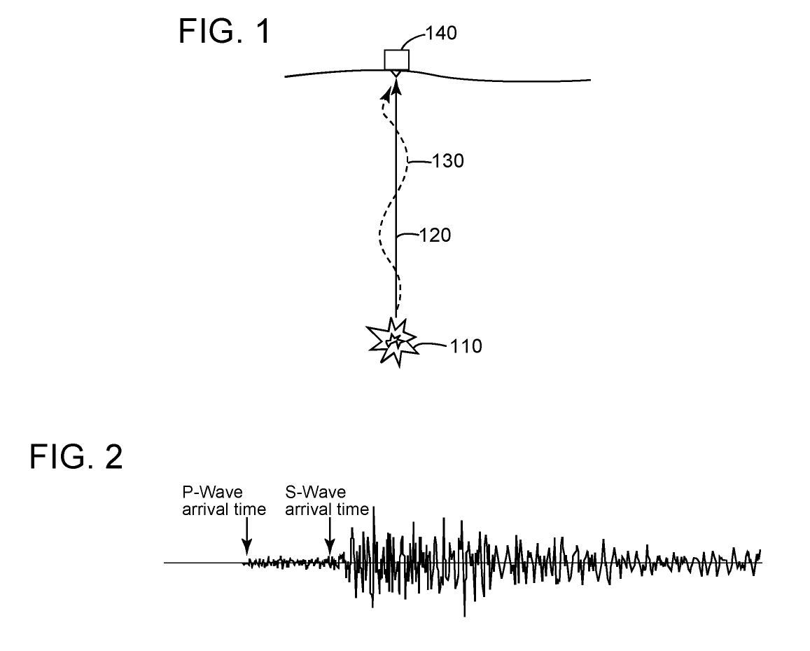

FIG. 1 illustrates an example of a calibration event generating P-waves and S-waves. A calibration event 110 may occur in a subterranean formation. Calibration event 110 will generate both P-waves 120 and S-waves 130. As shown in FIG. 1, a receiver 140 is deployed to detect both P-waves 120 and S-waves 130 associated with calibration event 110. Receiver 140 then converts P-waves 120 and S-waves 130 into signals that can be later used or detected, for example, electrical signals. For example, receiver 140 may measure the displacement in one or more directions caused by P-waves 120 and S-waves 130 at receiver 140. The signals of receiver 140 are then passed to a computing device for processing and analysis, and ultimately, for generating and calibrating a velocity model based on both P-wave and S-wave arrival times.

Calibration event 110 may be any seismic or microseismic event which is used to generate and calibrate a velocity model. For example, calibration event 110 may be a perforation shot, string shot, or other explosive force that generates P-waves and S-waves. For human-induced calibration events, the location of calibration event 110 may be a known value. For example, for a perforation shot, the operator of an oil or gas well will know the location of the well and at what depth they have discharged the perforation shot.

In certain circumstances, the origin time of one or more calibration events may be undetectable, not readily recordable, too inaccurate to be reliable, or is otherwise unknown. In such situations, the original time (t₀) may be referred to as being unknown.

In some embodiments, calibration event 110 may be a microseismic event where both location and origin time are undetectable or not recordable. For example, calibration event 110 may be a naturally occurring Earthquake or a microseismic event caused by hydraulic fracturing (sometimes referred to as “fracking”), damming a water flow (like a river or stream), natural heating and cooling and the consequent expansion and contraction of the ground, mining, or downhole events like drilling, injecting water or other liquid in a well to displace oil or gas or other purposes. For these events, the origin time and the location of the event are undetectable or not recordable. In some of these embodiments, a general time frame and a general locality of a microseismic event may be known, but the exact origin time and origin location of the microseismic event may still be unknown. For example, when hydraulic fracturing is being performed, an operator may be aware of when fluid is being pumped into the fracturing well (a general time frame) and the depth at which they are pumping (a general locality), but may not know exactly when fractures may be occurring (the exact origin time of the microseismic event). However, because the actual origin time cannot be detected or recorded, it is unknown. While some embodiments of calibrating events are disclosed above, it will be appreciated that any of a variety of such events are known in the art and fall within the scope of the present disclosure.

Receiver 140 of FIG. 1 may be any device configured to receive seismic waves and convert those seismic waves into a detectable signal. In some embodiments, receiver 140 may be a one component (1C) or a multicomponent (e.g. three component (3C)) receiver. Such a multicomponent receiver may be able to detect both P-waves (which may cause vertical motion) and S-waves (which may cause horizontal motion).

FIG. 2 illustrates an example of raw data indicating the arrival of both a P-wave and an S-wave. As shown in FIG. 2, the P-wave arrives before the S-wave, and the signals are different both in magnitude and shape. Using such data, the arrival times of both a P-wave and an S-wave at a particular receiver can be determined. By way of example, and in no way limiting, this can be done by automatically or manually selecting the arrival time. However, in some circumstances, the signal strength may be too weak from a single reading to pick the P-wave and S-wave arrival times. To address the signal weakness, the signal strength may be improved through processing. By way of example and in no way limiting, stacking of seismic wave data from more than one receiver may allow filtering because of timing errors or wave-shape differences to increase the SNR associated with the seismic wave. Other examples of signal filtering are numerous and varied and known to those skilled in the art having the benefit of this disclosure and are readily incorporated by one of ordinary skill in the art. Thus, the examples provided herein are in no way limiting as there are many other ways to enhance SNR that are known in the art and fall within the scope of the present disclosure.

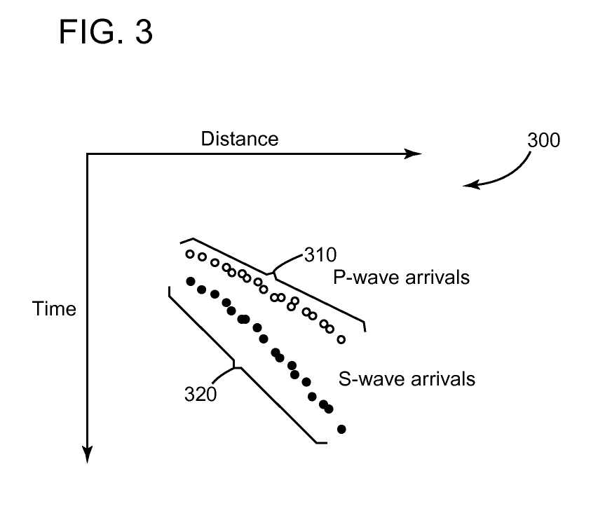

FIG. 3 illustrates an example plot of P-wave and S-wave arrival times against distance. Such a plot can facilitate using the arrival times of the P-waves and the S-waves to estimate the origin time (t₀) of a calibration event. The plot 300 includes a set of P-wave arrivals 310 (shown as hollow circles on plot 300) as well as a set of S-wave arrivals 320 (shown as solid circles on plot 300). For each P-wave arrival at a given distance, there is a corresponding S-wave arrival at some later time. It will be appreciated that while corresponding S-wave arrival times are shown for each P-wave, the illustrated collection of data has been idealized for convenience in illustrating the principles of the present disclosure. It will be appreciated that in actual practice, there may not be corresponding S-wave data points for each P-wave data point, and vice versa, for example, if the data is not recorded, recordable, or picked. For example, if a field of mixed 1C and 3C receivers are used, the 1C receivers may detect P-waves and 3C receivers may detect both P-waves and S-waves, yielding a larger data-set of P-wave data than S-wave data. This may be an artifact of the receivers used, or the quality of the data, or any other of a variety of factors as is known in the art.

When the origin location of a calibration event is known (for example, for a perforation shot, string shot, or other human-initiated event), the distance from the origin location to the receiver is readily ascertained and sets 310 and 320 can be readily plotted. However, for example as in passive microseismic event detection, the origin location of the calibration event may require estimation before sets 310 and 320 can be accurately plotted.

In some embodiments, an estimate may be made as to the origin location of the calibration event based on known information regarding the calibration event. As one illustrative example that is in no way limiting, during hydraulic fracturing, the depth of the calibration event may be estimated based on the depth at which fluid is being pumped. A location on the surface directly above the calibration event may be estimated based on signal strength and arrival times in multiple directions from the event. Using these two findings together, the origin location of the calibration event may be estimated. Other similar estimates may be made depending on the context and information available for a calibration event. While one example of estimating the origin location has been provided, many such estimates would be readily apparent to one of skill in the art and fall within the scope of the present disclosure. Whatever the cause of the calibration event, as will be discussed below, if the origin location is unknown there may be an increased level of variability as sets 310 and 320 may be inadvertently plotted too close or too far from the calibration event.

Best fit or other curve fitting approaches may be applied to plots of datasets 310 and 320 to yield one or more velocity models of varying type and complexity. As described above and by way of example, a 1D velocity model may be used for a simple velocity model, or a 3D anisotropic velocity model may be used for greater complexity. The origin time for each of the fitted curves can then be derived.

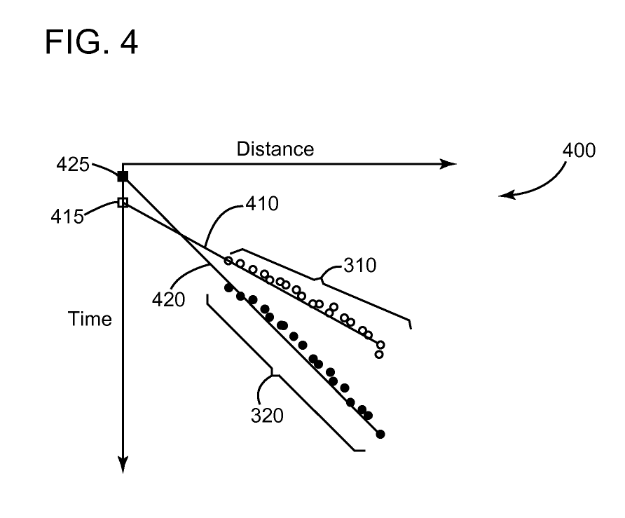

FIG. 4 illustrates an example plot of P-wave and S-wave arrival times against distance where the arrival times have been fit to a curve. Plot 400 includes sets 310 and 320 of P-wave and S-wave arrival times as plotted in FIG. 3. As shown in FIG. 4, in one embodiment, set 310 may be fit to a curve 410 defining the propagation rate of P-waves through the Earth. Additionally, curve 410 also defines an origin time based on P-waves, P-wave origin time 415 (t_{0(P)}). Set 320 of S-wave arrival times are also shown fit to a curve 420 that also defines an origin time, but here based on S-waves, S-wave origin time 425 (t_{0(S)}). The curves of FIG. 4 are shown to be linear. This corresponds to a zero-dimensional velocity model, or one that assumes a constant velocity throughout the Earth. These two curves are defined by the equations:

t_{P-obs}=t_{0(P)}+e₁·d (1)

t_{S-obs}=t_{0(S)}+f₁·d (2)

where t_{P-obs} represents the observed P-wave arrival time, or the P-wave arrival time at a given receiver, t_{S-obs} represents the observed S-wave arrival time, or the S-wave arrival time at a given receiver, e₁ and f₁ are coefficients representing the inverse of the respective constant velocities, and d represents the distance from the calibration event. While these equations represent some examples of generating velocity models, it will be appreciated that many others are known in the art and fall within the scope of the present disclosure.

As can be seen in FIG. 4, P-wave origin time 415 and S-wave origin time 425 are not the same. In fact, the difference between the two is likely to be outside of a convergence criteria. As used herein, the term convergence criteria will be used to designate when the difference between the two origin times is close enough for the intended purpose. For example, within the convergence criteria may refer to a difference between origin times that is not discernable when using the velocity model to detect the location of a microseismic event. For example, due to artifacts in measuring and signal processing, using a velocity model may be able to predict the location of a microseismic event to within twenty meters. If origin times 415 and 425 have a difference such that determining the location of a microseismic event is within fifteen meters, that difference is within the convergence criteria. The difference between origin times 415 and 425 may be non-zero and still be within the convergence criteria. However, if the difference in origin times 415 and 425 introduces a difference greater than the location resolution, in this example the difference would be outside of the convergence criteria. Using the numerical example above, if the difference caused a change in location of fifty meters and the location resolution is twenty meters, the difference is outside of the convergence criteria. Using convergence criteria may allow a velocity model to be precise enough for the intended purpose of the velocity model without imposing unnecessary and burdensome processing or analysis when it is unnecessary or undesirable. While one example of convergence criteria is described herein, it will be appreciated that many others will be recognized in the art and fall within the scope of the present disclosure.

If it is determined that the difference between origin times 415 and 425 is within the convergence criteria, the velocity model is considered to be a calibrated velocity model. For example, if P-wave data will be used in analyzing detected microseismic events, the P-wave velocity model may be selected and used as a calibrated velocity model for the microseismic events. Alternatively, if S-wave data will be used in analyzing detected microseismic events, the S-wave velocity model may be selected and used as a calibrated velocity model for the microseismic events.

If the difference is found to be outside the convergence criteria (for example, as shown in FIG. 4), it will be understood that a velocity model of a different type may be beneficial to model the propagation of the P-waves and the S-waves through the Earth with sufficient accuracy. For example, the complexity may be increased to better account for more variables. While complexity of a velocity model may be used as one example of varying the type of velocity model, it will be appreciated by those of skill in the art that there are many ways to vary the type of a velocity model, for example, by changing variables considered, filtering of data, or any of the factors described herein that may be considered in generating a velocity model.

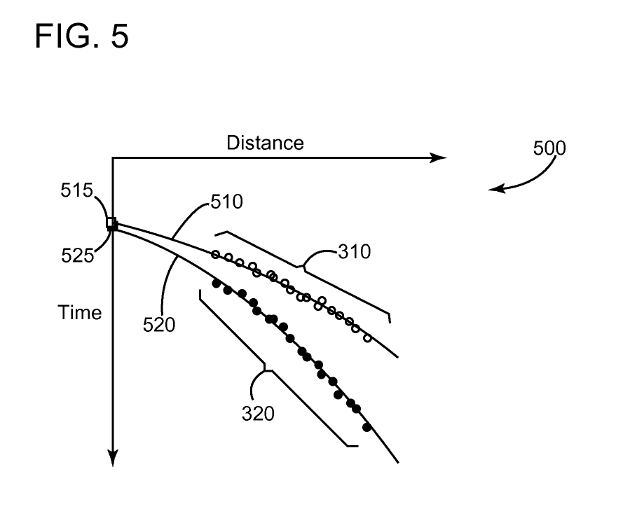

FIG. 5 illustrates another example plot of P-wave and S-wave arrival times against distance where the arrival times have been fit to a curve of a different type with increased complexity. As shown in FIG. 5, plot 500 includes set 310 of P-wave arrival times and set 320 of S-wave arrival times. Set 310 has been fit to a curve 510 of increased complexity when compared to curve 410 of FIG. 4. Additionally, set 320 has been fit to a curve 520 of increased complexity when compared to the level of complexity of curve 420 of FIG. 4. The complexity of the two velocity models are the same in this example. It will be appreciated that similar, although not identical, velocity models would also be within the scope of the present disclosure. Curves 510 and 520 may be defined by the following equations:

t_{P-Obs}=t_{0(P)}+e₁d+e₂depth² (3)

t_{S-Obs}=t_{0(S)}+f₁d+f₂depth² (4)

where e₁ and f₁ are variables indicating the variation in velocity based on distance, e₂ and f₂ are variables indicating the variation in velocity based on depth, and depth indicates the depth below the surface through which a wave is passing. Such curves may correspond to a velocity model that is one-dimensional, or one in which the velocity varies based on depth. While these equations represent some examples of generating velocity models, it will be appreciated that many others are known in the art and fall within the scope of the present disclosure.

As shown in FIG. 5, the origin time based on curve 510, P-wave origin time 515, and the origin time based on curve 520, S-wave origin time 525, are much closer together than they were in FIG. 4. This indicates that the velocity models are more accurately reflecting the propagation of waves through the Earth.

As described above, a determination may be made as to whether the difference between origin times 515 and 525 are within the convergence criteria. If they are within the convergence criteria, it can be determined that the velocity models describing the propagation rate of the P-waves and S-waves are calibrated and the velocity models may now be used to accurately predict the location of detected microseismic events. For example, if P-wave data associated with detected microseismic events will be used to predict the locations of the microseismic event, the P-wave velocity model may be used in that prediction. As another example, if S-wave data associated with detected microseismic events will be used to predict the locations of the microseismic events, the S-wave velocity may be used in that prediction. If it is determined that the difference between origin times 515 and 525 is still outside the convergence criteria, a different type of velocity model may be used, for example, an increased level of complexity may be added to the velocity models.

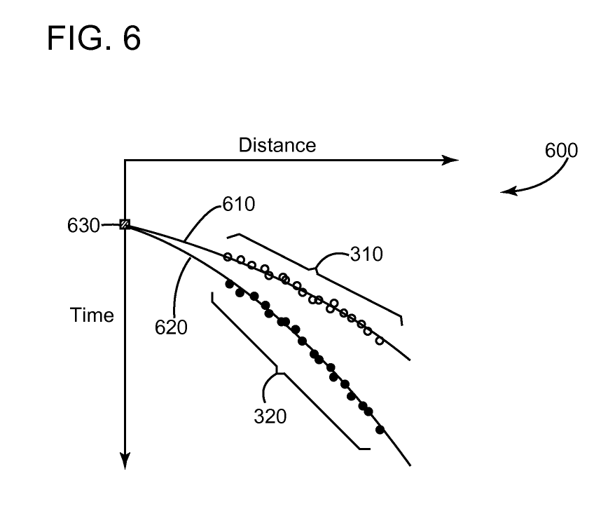

FIG. 6 illustrates an additional example plot of P-wave and S-wave arrival times against distance where the arrival times have been fit to a curve of a different type from those shown in FIGS. 4 and 5 of even further increased complexity. As shown in FIG. 6, plot 600 includes set 310 of P-wave arrival times and set 320 of S-wave arrival times. Set 310 has been fit to a curve 610 of increased complexity when compared to curve 510 of FIG. 5. Additionally, set 320 has been fit to a curve 620 of increased complexity when compared to the level of complexity of curve 520 of FIG. 5. As before, the complexity of the two velocity models are the same in this example, but could also be similar. Curves 610 and 620 may be defined by the following equations:

t_{P-Obs}=t_{0(P)}+e₁d+e₂d²+e₃depth²+e₄azimuth² (5)

t_{S-Obs}=t_{0(S)}+f₁d+f₂d²+f₃depth²+f₄azimuth² (6)

where e₁ and f₁ are variables indicating the variation in velocity based on distance, e₂ and f₂ are variables indicating the variation in velocity based on distance squared, e₃ and f₃ are variables indicating the variation in velocity based on depth, e₄ and f₄ are variables indicating the variation in velocity based on azimuth, and azimuth represents the angle formed between a reference direction and a line from the receiver to the location of the calibration event projected on the same plane as the reference direction. These equations may represent a velocity model which accounts for tilted transverse (TTI) anisotropy. While some examples of different velocity model equations have been given (for example, with respect to the curves shown in FIGS. 4, 5, and 6), it will be appreciated that many others are known in the art and fall within the scope of the present disclosure.

As shown in FIG. 6, the origin time based on curve 610, t_{0(P)}, and the origin time based on curve 620, t_{0(S)}, are a single identical origin time 630, and the difference between the two is zero. While this indicates a very accurate velocity model, this may be a type that is an overly complex velocity model. For example, if the velocity model of FIG. 5 is sufficient for the intended purpose (like microseismic event location determination), the increased complexity introduced by the type shown in curves 610 and 620 of FIG. 6 may be using increased computing resources and requiring additional burdensome work that is not providing any additional benefit.

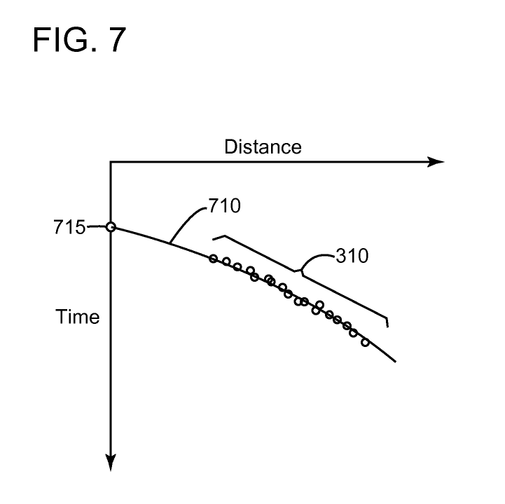

FIG. 7 illustrates an example of a finalized fit of P-wave arrival times on a plot of distance vs. time. As shown in FIG. 7, curve 710 (representing a velocity model) is selected from the velocity models used in FIGS. 4, 5, and 6. Curve 710 is the velocity model type that has the lowest level of complexity and is within the convergence criteria for the difference between the P-wave and S-wave origin times. For example, if the iterative process going from FIG. 4, to FIG. 5, to FIG. 6 were followed, and if FIG. 5 and FIG. 6 both were within the convergence criteria for the differences between the P-wave and S-wave origin times, the velocity model corresponding to the curve of FIG. 5 would be used. This velocity model has a corresponding finalized origin time 715. This velocity model may then be used in determining the location of a detected microseismic event. For example, using equation (3) defining the velocity model, the detected P-wave arrival times of a detected microseismic event, and an extrapolated depth at which the P-wave has been traveling, an origin location of the detected microseismic event may be determined.

While one example of location determination is given, it will be appreciated that any process of location determination using the calibrated velocity model may be used. The location of a microseismic event may be determined by any of a variety of processes and will be within the scope of the present disclosure. Determining location may also use more complex signal processing like stacking of seismic wave data from more than one receiver to strengthen the signal associated with the seismic wave and arrive at the location with the highest signal strength. Beam-forming (a signal processing technique that uses phased arrays of receivers for constructive interference at certain angles and destructive interference at other angles to strengthen a desired signal) or other signal processing techniques can also be used.

FIG. 7 shows a velocity model for P-wave arrival times, as most passive microseismic monitoring is done using P-waves. It will be appreciated, however, that an S-wave velocity model can also be selected as the calibrated velocity model, as both velocity models are calibrated using the principles of the present disclosure.

Additional types of velocity models, for example, those with greater complexity, may be introduced by introducing additional coefficients accounting for additional variations in velocity. For example, for a one-dimensional tabular vertical model, the propagation times may be represented by the equations:

t_{P-obs}=t_{0(P)}+e₁·d+e₂·d² (7)

t_{S-obs}=t_{0(S)}+f₁·d+f₂·d² (8)

or

t_{P-obs}=t_{0(P)}+e₁·d+e₂·depth² (9)

t_{S-obs}=t_{0(S)}+f₁·d+f₂·depth² (10)

or

t_{P-obs}=t_{0(P)}+e₁·d+e₂·offset² (11)

t_{S-obs}=t_{0(S)}+f₁·d+f₂·offset² (12)

where offset represents the distance from a point directly above the source at the surface to the receiver. As an additional example, for a velocity model in which vertical transverse isotropic (VTI) anisotropy is considered, the arrival times may be represented by the equations:

t_{P-obs}=t_{0(P)}+e₁d+e₂d²+e₃d³ (13)

t_{S-obs}=t_{0(S)}+f₁d+f₂d²+f₃d³ (14)

or

t_{P-obs}=t_{0(P)}+e₁d+e₂d²+e₃depth² (15)

t_{S-obs}=t_{0(S)}+f₁d+f₂d²+f₃depth² (16)

As the types of velocity models are varied as described above, for example by increasing complexity, the accuracy of the estimation of the origin time of the microseismic event may be increased. However, this may come at a cost of increased analysis time and processing power, or resource utilization. Thus, in some embodiments, a more simple and fast approach with less resource utilization may be preferable while in others a more robust approach with greater resource utilization may be desired. While these equations represent some examples of generating velocity models, it will be appreciated that many others are known in the art and fall within the scope of the present disclosure.

While the progression shown from FIG. 4 to FIG. 5 to FIG. 6 is one of types with slowly increasing complexity, it will be appreciated that one could just as easily go from the type of FIG. 4 to the type of FIG. 6, recognize that the difference between the two origin times is within the convergence criteria, and then change the type (for example by decreasing the complexity or some other factor that would decrease resource utilization) until the difference becomes outside of the convergence criteria, and then use the velocity model that was the least resource-expensive that was within the convergence criteria (for example, the next most complex type after the type that fell outside of the convergence criteria).

In circumstances in which the origin location is unknown, the same iterative process may be followed. However, rather than merely varying the type of the velocity model used, the estimated origin location is also varied until a combination of velocity model and estimated origin location is found where the origin time difference is within the convergence criteria.

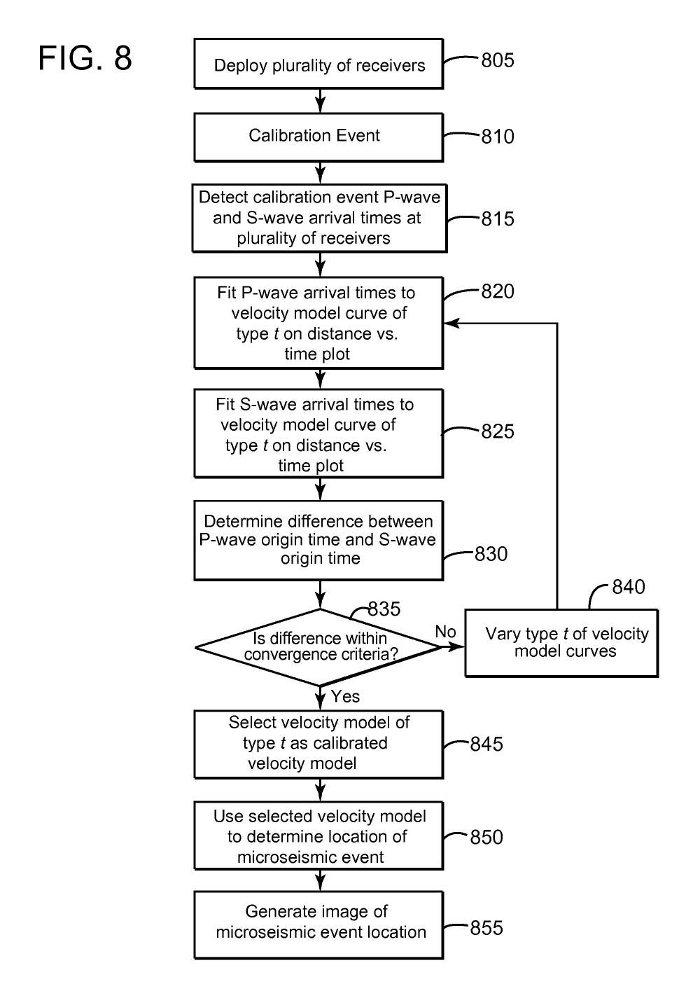

FIG. 8 illustrates an example of a flowchart illustrating a process to generate a calibrated velocity model. At step 805, a plurality of receivers able to detect both P-waves and S-waves are deployed. At step 810, a calibration event occurs, which generates both P-waves and S-waves. As described above, this may be a human-induced calibration event in which the origin location is known, or it may be a calibration event in which the origin location is unknown. In either case, the origin time is unknown. At step 815, the plurality of receivers detect the P-waves and S-waves generated by the calibration event and the arrival times for the P-waves and S-waves at the plurality of receivers is found.

At step 820, the P-wave arrival times are plotted on a distance versus time plot and fit to a curve describing the P-wave propagation rate through the Earth, or in other words, a velocity model curve, of type t. This curve will have a corresponding P-wave origin time where the curve defining the P-wave arrival times crosses the time axis. In the embodiment shown in FIG. 8, this first type t may be at a low level of complexity or some other low-resource utilizing type of velocity model. At step 825, the S-wave arrival times are also plotted on the distance versus time plot and fit to a velocity model curve of the same or similar type t. This curve will have a corresponding S-wave origin time.

At step 830, a determination is made as to the difference between the P-wave origin time and the S-wave origin time. At step 835, it is determined whether the difference between the P-wave origin time and the S-wave origin time is within the convergence criteria. For example, the difference between the origin times may correspond to a difference in location determination smaller than the resolution possible. Upon a determination that the difference is within the convergence criteria, at step 845, the velocity model of type t is selected as a calibrated velocity model. If however, the difference is outside the convergence criteria, at step 840, the type t is varied (for example, the complexity may be increased) and the process returns to step 820 where the P-wave arrival times are fit to a curve of a different type.

Once a calibrated velocity model is selected at step 845, that velocity model may be used to determine the location of a detected microseismic event at step 850. As described above, this may include any of a variety of location determination processes that use the calibrated velocity model. Additionally, once the location of the microseismic event has been determined, an image depicting the location of the microseismic event may be generated. The image may include other subterranean features or formations, and may simply overlay the microseismic event location on such an image.

While FIG. 8 is shown as occurring in a linear fashion, it will be appreciated that various steps may be done in various orders or may be removed completely. For example, steps 805, 840, 850, and 855 may all be omitted. Additionally, steps 820 and 825 may be done in reverse order.

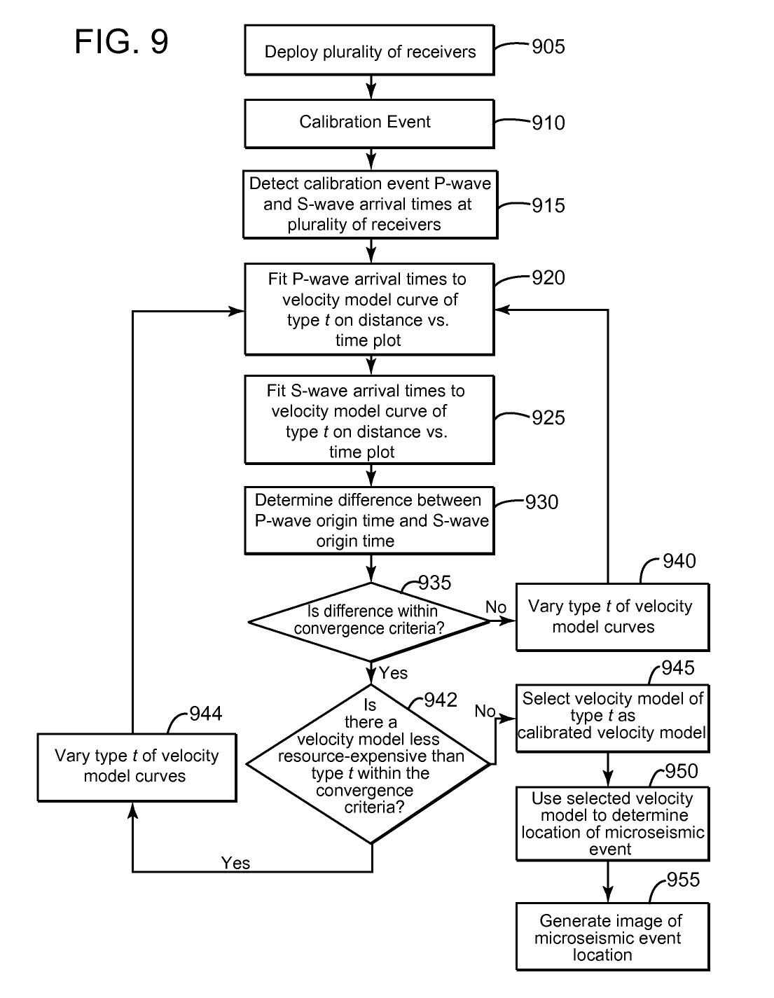

FIG. 9 illustrates another example of a flowchart illustrating a process to generate a calibrated velocity model. At step 905, a plurality of receivers able to detect both P-waves and S-waves are deployed. At step 910, a calibration event occurs, which generates both P-waves and S-waves and has an unknown origin time. As described above, this may be a human-induced calibration event in which the origin location is known, or it may be a calibration event in which the origin location is unknown. At step 915, the plurality of receivers detect the P-waves and S-waves generated by the calibration event and the arrival times for the P-waves and S-waves at the plurality of receivers is found.

At step 920, the P-wave arrival times are plotted on a distance versus time plot and fit to a curve describing the P-wave propagation rate through the Earth, or in other words, a velocity model curve, of type t. This curve will have a corresponding P-wave origin time. In the embodiment shown in FIG. 9, this first type t can be at any type, including a very high resource-using type (for example, a very high level of complexity). At step 925, the S-wave arrival times are also plotted on the distance versus time plot and fit to a velocity model curve of the same or similar type t. This curve will have a corresponding S-wave origin time.

At step 930, a determination is made as to the difference between the P-wave origin time and the S-wave origin time. At step 935, it is determined whether the difference between the P-wave origin time and the S-wave origin time is within the convergence criteria. For example, the difference between the origin times may correspond to a difference in location determination smaller than the resolution possible.

Upon a determination that the difference is within the convergence criteria, the process proceeds to step 942. At step 942, a further determination is made as to whether there is a type of velocity model that is less resource-expensive (for example, is less complex than type t), but where the difference between the P-wave and S-wave origin times is still within the convergence criteria. If it is determined that there is or may be such a velocity model, the process proceeds to step 944 where the type t of the velocity model curves is varied, for example, to a type that is less resource-expensive. The process then returns to step 920 to re-fit the P-wave arrival times to the new type of velocity model. If however, it is determined that there is not a type of velocity model with that is less resource-expensive that still provides for a difference between the P-wave and S-wave origin times that falls within the convergence criteria, the velocity model of type t is selected as a calibrated velocity model.

Once a calibrated velocity model is selected at step 945, that velocity model may be used to determine the location of a detected microseismic event at step 950. As described above, this may include any of a variety of location determination processes that use the calibrated velocity model. Additionally, once the location of the microseismic event has been determined, an image depicting the location of the microseismic event may be generated. The image may include other subterranean features or formations, and may simply overlay the microseismic event location on such an image.

At step 935, if it is determined that the type t of the velocity curves produces a difference between P-wave and S-wave origin times outside of the convergence criteria, at step 940, the type t is varied (for example, by increasing the complexity) and the process returns to step 920 where the P-wave arrival times are re-fit to a curve with an increased complexity c.

While FIG. 9 is shown as occurring in a linear fashion, it will be appreciated that various steps may be done in various orders or may be removed completely. For example, steps 905, 940, 944, 950, and 955 may all be omitted. Additionally, steps 920 and 925 may be done in reverse order.

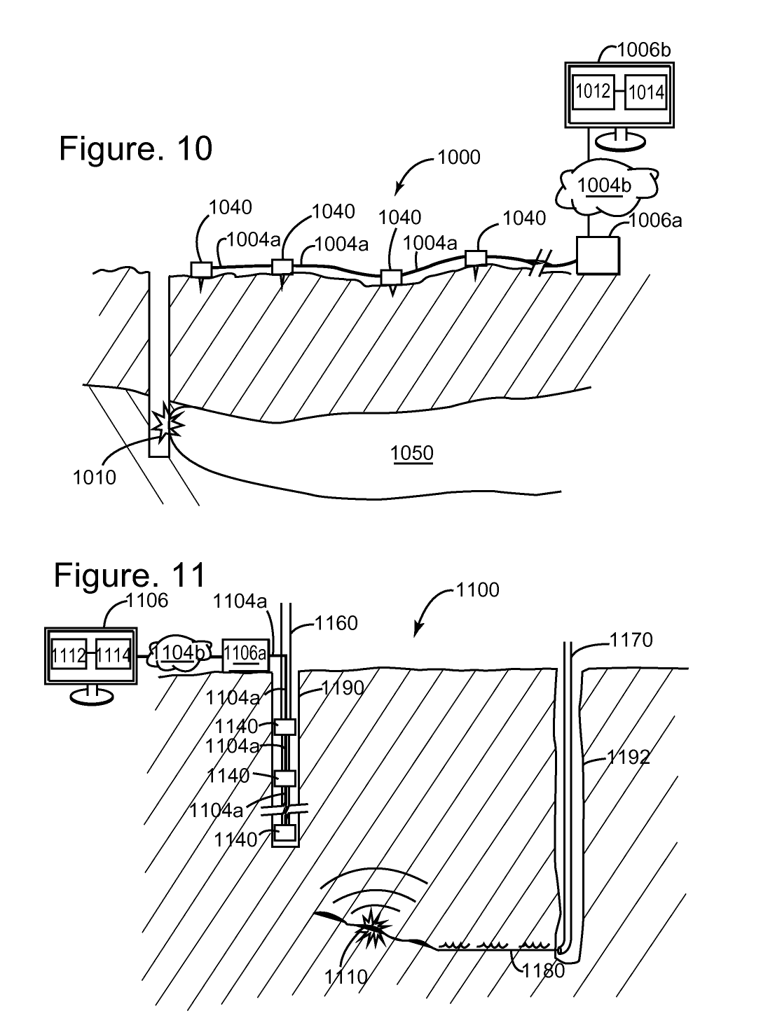

FIG. 10 illustrates an example of a system for generating a calibrated velocity model. System 1000 may monitor for and detect a calibration event 1010 and generate a calibrated velocity model based on both detected P-waves and S-waves. System 1000 may be any collection of systems, devices, or components configured to detect, record, or process data associated with a calibration event in a subterranean formation. For example, system 1000 may include one or more receivers, for example, receivers 1040, communicatively coupled to one or more computing devices, for example, computing device 1006a and 1006b, via one or more networks, for example networks 1004a and 1004b. A plurality of receivers 1040 are connected by a first network 1004a. First network 1004a connects receivers 1040 with a first computing device 1006a. First computing device 1006a is connected to a second computing device 1006b via a second network 1004b. System 1000 monitors for a calibration event, for example, calibration event 1010, and measures or senses data associated with calibration event 1010. System 1000 additionally processes data associated with calibration event 1010.

System 1000 may also monitor for microseismic events within subterranean formations. As used herein, a subterranean formation may refer to a single rock layer or a collection of rock layers. A subterranean formation may also refer to a particular arrangement of rock layers, which may include some particular feature within the rock layers. For example, a subterranean formation may include a trap or other feature where hydrocarbons have collected in a pool or reservoir. A subterranean formation may also include one or more rock layers containing a producing well, an observation well, a hydraulic fracturing well, or any other feature to access or observe a subterranean formation.

As shown in FIG. 10, in some embodiments, calibration event 1010 may be a perforation shot or string shot that occurs proximate a reservoir 1050 of oil or gas. In such an embodiment, the origin location of calibration event 1010 may be known while the origin time is unknown. Calibration event 1010 may also be any of the events described with respect to calibration event 110 of FIG. 1. For example, calibration event 1010 may be a naturally-induced microseismic event or a microseismic event caused by man-made operations. This may include any circumstance in which human action changes the stress fields within subsurface formations. Some examples may include hydraulic fracturing, damming a water flow (like a river or stream), heating the ground, cooling the ground, mining, and downhole events like drilling, injecting water or other liquid in a well to displace oil or gas, and the discharge of downhole explosives.

System 1000 uses one or more receivers to detect or measure information regarding calibration event 1010 or a microseismic event. Receivers 1040 may be located on or proximate to the surface of the Earth within an area being monitored for microseismic events. Receivers 1040 may be any type of instrument that is utilized to transform seismic energy or vibrations into a readable signal. For example, receivers 1040 may be geophones configured to detect or record energy waves from calibration event 1010 and convert the mechanical motion experienced at the receiver into an electrical signal. Receivers 1040 may also be accelerometers that sense the change in acceleration at receivers 1040 due to calibration event 1010 and convert that change in acceleration to an electrical signal. Receivers 1040 may also be optical devices or optical geophones, for example, distributed acoustic sensing (DAS) devices. In such an embodiment, receivers 1040 output a digital signal representative of the optical phase in an interferometer, which varies in response to mechanical motion. Receivers 1040 may comprise vertical, horizontal, or multicomponent receivers. For example, receivers 1040 may be multicomponent receivers like 3C geophones, 3C accelerometers, or 3C Digital Sensor Units (DSU).

In some embodiments, an array of receivers may be spread out to monitor for microseismic events. In a given array of a large number (for example, two thousand) single component (1C) vertical receivers, a small number (for example, four) of multicomponent receivers may be deployed as part of the array. These multicomponent receivers may be able to detect both P-waves (which may cause vertical motion) and S-waves (which may cause horizontal motion). The data from these multicomponent receivers may be used to generate the velocity model applicable to the data gathered from the remainder of the 1C receivers in the array. While any number of 3C and 1C receivers may be used, this example serves to illustrate that a much smaller number of the more expensive 3C receivers may be used while still generating a beneficial velocity model based on both P-wave and S-wave data. For example, the number of 3C receivers may be three orders of magnitude smaller than the number of 1C receivers.

In addition to an array of mixed 3C and 1C receivers, an array of only 3C or only 1C receivers may also be used. If the entire array of receivers includes only 3C receivers, then any of the receivers may be used to detect S-waves. If the entire array of receivers includes only 1C receivers, the S-waves will have to be detected at a receiver at a long offset from the source. With a great enough distance from the source, the motion of the particles of the S-wave are detectable by a 1C vertical receiver. Thus, for a given array of only 1C receivers, it may be the receivers at the periphery of the array that detect the S-waves while the 1C receivers proximate the microseismic event may detect the P-waves. In some embodiments, observation over time may be performed, which may be referred to as four-dimensional (4D) monitoring.

Multiple receivers may be utilized within an area to provide data related to multiple locations and distances from calibration event 1010. The receivers may be positioned in multiple configurations, such as linear, grid, array, or any other suitable configuration. In some embodiments, the receivers are positioned along one or more strings, which are part of network 1004a. Each of the receivers may be spaced apart from adjacent receivers in the same string. Spacing between receivers in a string may be approximately the same preselected distance, or span, or spacing may vary depending on a particular application, area topology, or other suitable parameter.

Computing devices 1006a and 1006b, either separately or together, perform the processing and analysis of the raw data associated with a calibration event to generate and calibrate a velocity model based on both P-waves and S-waves. Computing devices 1006a and 1006b may include any instrumentality or aggregation of instrumentalities operable to compute, classify, process, transmit, receive, store, display, record, or utilize any form of information, intelligence, or data. For example, computing devices 1006a and 1006b may comprise a personal computer, a storage device, or any other suitable device and may vary in size, shape, performance, functionality, and price. Computing devices 1006a and 1006b may include a processing unit 1012 and a memory unit 1014. For example, computing device 1006a and 1006b may include random access memory (RAM), one or more processing resources such as a central processing unit (CPU) or hardware or software control logic, other types of volatile or non-volatile memory, or any combination of the foregoing. Additional components of computing device 1006a and 1006b may include one or more disk drives, one or more network ports for communicating with external devices, various input and output (I/O) devices, such as a keyboard, a mouse, and a video display. Computing device 1006a may be located in a station truck or any other suitable enclosure. Computing devices 1006a and 1006b may be configured to permit communication over any type of network 1004a or 1004b, such as a wireless network, a local area network (LAN), a wide area network (WAN) (for example, the Internet), or any combination thereof.

Processing unit 1012 may comprise any system, device, or apparatus operable to interpret program instructions, execute program instructions, process data, or any combination thereof. Processing unit 1012 may include, without limitation, a microprocessor, microcontroller, digital signal processor (DSP), application specific integrated circuit (ASIC), or any other digital or analog circuitry configured to interpret program instructions, execute program instructions, process data, or any combination thereof. In some embodiments, processing unit 1012 may interpret program instructions, execute program instructions, or process data stored in memory 1014, storage resources, another component of computing device 1006a or 1006b, or any combination thereof.

Memory unit 1014 may be communicatively coupled to processing unit 1012 and may comprise any system, device, or apparatus operable to retain program instructions or data for a period of time (for example, computer-readable media). Memory unit 1014 may comprise random access memory (RAM), electrically erasable programmable read-only memory (EEPROM), a PCMCIA card, flash memory, magnetic storage, opto-magnetic storage, or any suitable selection or array of volatile or non-volatile memory that retains data after power to computing device 1006b is turned off.

In some embodiments, computing devices 1006a and 1006b may be located in close proximity to each other, or may be remotely located from each other. Computing devices 1006a and 1006b may also vary greatly in their type, components, or make-up, but need not do so. For example, computing device 1006a may be a simple computing device primarily configured to collect raw data from receivers 1040 and provide the data to computing device 1006bb. Alternatively, computing device 1006b may be a super-computer configured to perform exhaustive, complex, multi-variable and multi-dimensional computation and processing.

Network 1004a may provide wire-line transmission between receivers 1040 and computing device 1006a. Computing device 1006a may then be in communication with computing device 1006b via network 1004b, which may be via wire-line or wireless transmission. It may also be described that receivers 1040 are communicatively coupled with computing device 1006b. For example, they may be coupled through networks 1004a and 1004b and computing device 1006a. Computing devices 1006a and 1006b can be described as a single computing device.

For the purposes of this disclosure, the term “wire-line transmissions” may be used to refer to all types of electromagnetic or optical communications over wires, cables, or other types of conduits. Examples of such conduits include, but are not limited to, metal wires and cables made of copper or aluminum, fiber-optic lines, and cables constructed of other metals or composite materials satisfactory for carrying electromagnetic or optical signals. Wire-line transmissions may be conducted in accordance with teachings of the present disclosure over electrical power lines, electrical power distribution systems, building electrical wiring, conventional telephone lines, Ethernet cabling (10baseT, 100baseT, etc.), coaxial cables, T-1 lines, T-3 lines, ISDN lines, ADSL, or any other suitable medium.

For the purposes of this disclosure, the term “wireless transmissions” may be used to refer to all types of electromagnetic communications that do not require a wire, cable, or other types of conduits. Examples of wireless transmissions which may be used include, but are not limited to, personal area networks (PAN) (for example, BLUETOOTH), local area networks (LAN), wide area networks (WAN), narrowband personal communications services (PCS), broadband PCS, circuit switched cellular, cellular digital packet data (CDPD), radio frequencies, such as the 800 MHz, 900 MHz, 1.9 GHz and 2.4 GHz bands, infra-red and laser.

Examples of wireless transmissions for use in local area networks (LAN) include, but are not limited to, radio frequencies, especially the 900 MHZ and 2.4 GHz bands, for example IEEE 802.11 and BLUETOOTH, as well as infrared, and laser. Examples of wireless transmissions for use in wide area networks (WAN) include, but are not limited to, narrowband personal communications services (nPCS), personal communication services (PCS such as CDMA, TMDA, GSM, UMTS, LTE, etc.) circuit switched cellular, and cellular digital packet data (CDPD), etc.

Networks 1004a and 1004b may be any instrumentality or aggregation of instrumentalities operable to provide data communication between one or more devices, in one or both directions. In some embodiments, networks 1004a and 1004b may be implemented as, or may be a part of, a personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data, or messages (generally referred to as data), or any combination thereof. Networks 1004a and 1004b may transmit data using wireless transmissions, wire-line transmissions, or a combination thereof via any storage protocol, communication protocol, or combination thereof, including without limitation, Fibre Channel, Frame Relay, Asynchronous Transfer Mode (ATM), Internet protocol (IP), Transmission Control Protocol (TCP), Internet Printing Protocol (IPP), other packet-based protocol, or any combination thereof. Networks 1004a and 1004b and their various components may be implemented using hardware, software, or any combination thereof.

FIG. 11 illustrates another example of a system for generating a calibrated velocity model. Similar components having a similar description to those shown in FIG. 10 are present in FIG. 11, and so the written description of those components is not duplicated with an understanding that the same description of these components with respect to FIG. 10 are equally applicable to the components shown in FIG. 11. For example, receivers 1040 of FIG. 10 are comparable to receivers 1140 of FIG. 11. Networks 1004a and 1004b are comparable to networks 1104a and 1104b. Computing devices 1006a and 1006b are comparable to computing device 1106a and 1106b.

System 1100 shown in FIG. 11 may be one example of a system utilized to generate a calibrated velocity model in preparation for passively monitoring for microseismic events caused by hydraulic fracturing. As shown in FIG. 11, an injection system 1170 may be disposed within a well 1192 to facilitate hydraulic fracturing. For example, a high-pressure fluid 1180 may be injected into well 1192 causing micro-fractures in the rock formations. These micro-fractures may occur at or along fault 1140 and may result in microseismic events that can be used as a calibration event such as calibration event 1110.

As shown in FIG. 11, rather than being disposed along the surface of the ground, receivers 1140 may be disposed within an observation well 1190 or other underground location like a mineshaft. Receivers 1140 may be attached to a drill string 1160, or may be coupled to any other apparatus or device configured to be disposed within an observation well 1190. Receivers 1140 may also be placed directly upon the rock surface within observation well 1190. Receivers 1140 may also be permanently cemented into place in observation well 1190. In some embodiments, receivers 1140 may be utilized for observation over time, which may be referred to as four-dimensional (4D) monitoring.

As shown in FIG. 11 and similarly to the arrangement shown in FIG. 10, receivers 1140 may be communicatively coupled to computing device 1106a via network 1104a. Computing device 1106a may be communicatively coupled with computing device 1106b via network 1104b. Computing devices 1106a and 1106b and network 1104b may be collapsed into a single computing device.

In generating and calibrating a velocity model based on P-waves and S-waves, an application, program, or grouping thereof operating on a computing device may be used. This application, program, or grouping thereof is stored on a medium that is discernible by a computer and may be referred to as a computer-readable media. Computer-readable media may include any instrumentality or aggregation of instrumentalities that may retain data or instructions for a period of time. Computer-readable media may include, without limitation, storage media such as a direct access storage device (for example, a hard disk drive or floppy disk), a sequential access storage device (for example, a tape disk drive), compact disk, CD-ROM, DVD, random access memory (RAM), read-only memory (ROM), electrically erasable programmable read-only memory (EEPROM), flash memory, or any combination of the foregoing.

In certain example implementations, a velocity model generated and calibrated based on P-waves and S-waves is used for one or more drilling operations, workover operations, or enhancement operations. For example, the velocity model generated and calibrated based on P-waves and S-waves may be used to generate an image to determine where to initiate a borehole in the Earth and may further be used to determine a drillpath. In other example implementations, velocity model generated based on P-waves and S-waves is used to generate an image to determine where to initiate a fracture in a subsurface formation.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The foregoing description of exemplary embodiments refers to the accompanying drawings. The same reference numbers in different drawings identify the same or similar elements. The foregoing detailed description does not limit the disclosure. Instead, the scope of the disclosure is defined by the appended claims. Some of the foregoing embodiments are discussed, for simplicity, with regard to the terminology and structure of generating and calibrating a velocity model using both P-waves and S-waves. The embodiments, however, are not limited to these configurations, and may be extended to other arrangements.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

1. A method of processing seismic data comprising:
detecting arrival times of both a P-wave and an S-wave at a plurality of receivers, the P-wave and the S-wave generated by a calibration event in a subterranean formation;
obtaining a distance for each of the plurality of receivers to an origin location of the calibration event;
fitting the P-wave arrival times as a first curve on a plot of the distance versus time based on a first velocity model with a first type;
fitting the S-wave arrival times as a second curve on the plot of the distance versus time based on a second velocity model with a second type similar to the first type;
determining a difference between a first origin time based on the first curve and a second origin time based on the second curve; and
upon a determination that the difference between the first origin time and the second origin time is within a convergence criteria, selecting the first velocity model as a calibrated velocity model of the subterranean formation.

2. The method of claim 1, further comprising, upon a determination that the difference between the first origin time and the second origin time is outside the convergence criteria:
re-fitting the P-wave arrival times to a third curve based on a third velocity model with a third type;
re-fitting the S-wave arrival times to a fourth curve based on a fourth velocity model with a fourth type similar to the third type;
determining a difference between a third origin time based on the third curve and a fourth origin time based on the fourth curve; and
upon a determination that the difference between the third origin time and the fourth origin time is within the convergence criteria, selecting the third velocity model as the calibrated velocity model of the subterranean formation.

3. The method of claim 2, wherein the third type is more complex than the first type.

4. The method of claim 1, wherein a location of the calibration event is known.

5. The method of claim 1, wherein the first type accounts for one of vertical variations in velocity, three-dimensional variations in velocity or variations in velocity due to wave-propagation direction.

6. The method of claim 1, further comprising determining an origin location of a microseismic event detected by the plurality of receivers based on the calibrated velocity model.

7. The method of claim 6, wherein the microseismic event is triggered by hydraulic fracturing.

8. The method of claim 6, further comprising generating an image depicting the origin location of the microseismic event.

9. A system for processing seismic data comprising:
a plurality of receivers to detect both a P-wave and an S-wave of a calibration event in a subterranean formation;
a network communicatively coupled to the plurality of receivers; and
a computing unit communicatively coupled to the plurality of receivers via the network, the computing unit comprising a processing unit and a memory unit coupled to the processing unit, the memory unit including instructions that, when executed by the processing unit, are configured to:
detect arrival times of both the P-wave and the S-wave at the plurality of receivers;
obtain a distance for each of the plurality of receivers to an origin location of the calibration event;
fit the P-wave arrival times as a first curve on a plot of the distance versus time based on a first velocity model with a first type;
fit the S-wave arrival times as a second curve on the plot of the distance versus time based on a second velocity model with a second type similar to the first type;
determine a difference between a first origin time based on the first curve and a second origin time based on the second curve;
upon a determination that the difference between the first origin time and the second origin time is within a convergence criteria, select the first velocity model as a calibrated velocity model of the subterranean formation; and
upon a determination that the difference between the first origin time and the second origin time is outside the convergence criteria:
re-fit the P-wave arrival times to a third curve based on a third velocity model with a third type;
re-fit the S-wave arrival times to a fourth curve based on a fourth velocity model with a fourth type similar to the third type;
determine a difference between a third origin time based on the third curve and a fourth origin time based on the fourth curve; and
upon a determination that the difference between the third origin time and the fourth origin time is within the convergence criteria, select the third velocity model as the calibrated velocity model of the subterranean formation.

10. The system of claim 9, wherein the plurality of receivers comprise one of geophones, accelerometers, or optical geophones.

11. The system of claim 9, wherein the plurality of receivers comprise one of 1C receivers, 3C receivers, or a combination of 1C and 3C receivers.

12. The system of claim 11, wherein the number of 3C receivers is three orders of magnitude smaller than the number of 1C receivers.

13. The system of claim 9, the instructions further configured to determine a location of a microseismic event using the calibrated velocity model.

14. The system of claim 13, the instructions further configured to generate an image depicting the origin location of the microseismic event.

15. The system of claim 13, further comprising an injection system configured to inject liquid into a wellbore to induce hydraulic fracturing and wherein the microseismic event is caused by the hydraulic fracturing.

16. The system of claim 15, further comprising a monitoring well for monitoring progress of the hydraulic fracturing and wherein at least one of the plurality of receivers is located in the monitoring well.

17. A non-transitory computer-readable medium containing instructions for processing seismic data that, when executed by a processor, are configured to:
receive data indicative of arrival times of both a P-wave and an S-wave at a plurality of receivers, the P-wave and S-wave generated by a calibration event in a subterranean formation;
obtain a distance for each of the plurality of receivers to an origin location of the calibration event;
fit the P-wave arrival times as a first curve on a plot of the distance versus time based on a first velocity model with a first type indicating a first origin time;
fit the S-wave arrival times as a second curve on the plot of the distance versus time based on a second velocity model with a second type similar to the first type;
determine a difference between a first origin time based on the first curve and a second origin time based on the second curve; and
upon a determination that the difference between the first origin time and the second origin time is within a convergence criteria, select the first velocity model as a calibrated velocity model of the subterranean formation.

18. The computer-readable medium of claim 17, the instructions further configured to, upon a determination that the difference between the first origin time and the second origin time is outside the convergence criteria:
re-fit the P-wave arrival times to a third curve based on a third velocity model with a third type different than the first type;
re-fit the S-wave arrival times to a fourth curve based on a fourth velocity model with a fourth type similar to the third type;
determine a difference between a third origin time based on the third curve and a fourth origin time based on the fourth curve; and
upon a determination that the difference between the third origin time and the fourth origin time is within the convergence criteria, select the third velocity model as the calibrated velocity model of the subterranean formation.

19. The computer-readable medium of claim 17, the instructions further configured to determine an origin location of a microseismic event detected by the plurality of receivers based on the calibrated velocity model.

20. The computer-readable medium of claim 19, the instructions further configured to generate an image depicting the origin location of the microseismic event.
